(19) United States
(12) Patent Application Publication
(10) Pub. No.: US 2026/0085753 A1
(43) Pub. Date: Mar. 26, 2026

(54) SNAP-ON SEALING RING FOR EXTERNALLY SEALING A SHAFT CONNECTION

(71) Applicant: Volkswagen Aktiengesellschaft, Wolfsburg (DE)

(72) Inventors: Gregor Schaaf, Wolfsburg (DE); Jan Eric Kuhnt, Wolfsburg (DE)

(21) Appl. No.: 19/331,934

(22) Filed: Sep. 17, 2025

(30) Foreign Application Priority Data
Sep. 20, 2024 (DE) 102024209039.5

(51) Int. Cl. F16J 15/3268; F16J 15/3228

(52) U.S. Cl. CPC F16J 15/3268; F16J 15/3228

(57) ABSTRACT

A snap-on sealing ring for externally sealing a shaft connection includes a plastic base body with a sleeve section and an axially adjoining flange section, and at least one catch lug configured to latch to a first component. A metal insert has an outer ring-disk section, an inner ring-disk section axially offset from the outer ring-disk section, and a sleeve-shaped connecting section that joins the ring-disk sections. The outer ring-disk section is embedded, at least in part, in the flange section. The inner ring-disk section has a smaller inside diameter than the sleeve and flange sections. The connecting section forms, on its radial inner side, a contact surface for pressing onto a shaft section of a second component, while its radial outer side is in contact with the plastic base body. The arrangement provides robust sealing and precise positioning over a wide temperature range.

### RELATED APPLICATIONS

The present application claims priority to German Patent App. No. DE 10 2024 209 039.5, to Schaaf, et al., filed Sep. 20, 2024, the contents of each being incorporated by reference in their entirety herein.

### TECHNICAL FIELD

The present disclosure relates to the field of automotive engineering, and more particularly to a snap-on sealing ring for externally sealing a shaft connection.

### BACKGROUND

Axially clamped face serration assemblies, also referred to as Hirth joints or face gearing systems, are used as connections for play-free torque transmission in vehicle construction, for example between a drive shaft and a wheel hub. When transmitting high torque, especially in motor vehicles comprising an electric drive, axially clamped face serration assemblies provide advantages over conventional spline systems. In particular, such assemblies enable torque transmission under high and varying torque loads without relative movement caused by the torsional elasticity of splines, and without producing interfering noise such as ping noise.

To ensure reliable torque transmission, the face serration assembly must be clamped using a high axial force. The two face serrations, which are subjected to high material stresses and are engaged with one another, must therefore be appropriately protected against corrosion. In addition, during assembly it must be ensured that the corresponding face serrations properly mesh with one another, so as to prevent tooth-on-tooth assembly.

In this context, a snap-on sealing ring for protecting a face serration assembly is known from DE 10 2008 050 127 A1. This ring includes a sleeve with a catch lug that is flared inwardly. A sealing lip, which is pushed over a shaft section, is arranged radially on the inside of the sleeve. However, no axial seal is provided. Instead, moisture can penetrate into the gap between the snap-on sealing ring and the wheel hub and then accumulate on the sealing lip. Because the sealing lip rests against a metal component, rust can form beneath this point over time. At least this location must therefore be additionally protected against corrosion.

### SUMMARY

Some aspects of the present disclosure provide cost-effective sealing solutions for shaft connections, such as those encountered in the installation situations described above, that offer a high level of protection against moisture ingress and rust travel without requiring costly surface corrosion protection of the affected components, including under conditions relevant to vehicle construction such as salt spray and changing temperatures.

In some aspects, a snap-on sealing ring for externally sealing a shaft connection is provided. The sealing ring includes a base body made of plastic material having a sleeve section and a flange section that axially adjoins the sleeve section, and at least one catch lug configured to latch with a first component, the catch lug being formed radially on the inside or on the outside of the sleeve section. The sealing ring further includes a metal insert having an outer ring disk section, an inner ring disk section that is axially offset from the outer ring disk section, and a sleeve-shaped connecting section that connects the outer and inner ring disk sections. The outer ring disk section is embedded at least in sections into the flange section. The inner ring disk section has a smaller inside diameter than the sleeve section and the flange section. The sleeve-shaped connecting section forms, on its radial inner side, a contact surface for pressing onto a shaft section of a second component, and on its radial outer side is in contact with the plastic material of the base body.

In other aspects, an axially clamped face serration assembly is provided. A first component includes a first face serration and a second component includes a second face serration, the face serrations being in toothing engagement and axially clamped to one another. A snap-on sealing ring of the type summarized above surrounds the first and second face serrations radially on the outside and seals them. The sealing ring is pressed onto a shaft step at one of the components by way of the contact surface of the sleeve-shaped connecting section, and engages, via the at least one catch lug, with axial play in one or more recesses at the other component. The sealing ring further has, axially at its end face, a circumferential sealing surface that is configured to be pushed against the other component, or against a sealing element arranged thereon, when a zero-backlash assembly position of the face serrations has been reached.

In further aspects, a non-contact wheel bearing pre-seal is provided between a wheel carrier on the one hand and a wheel hub, a wheel bearing, and/or a journal on the other hand. A snap-on sealing ring of the type summarized above is attached to the wheel hub, the wheel bearing, and/or the journal and, along its flange section, cooperates with a mating contour present at the wheel carrier or at a component attached to the wheel carrier to form a sealing gap.

### BRIEF DESCRIPTION OF THE DRAWINGS

Aspects of the present disclosure will be described hereafter in greater detail based on exemplary embodiments illustrated in the drawings. In the drawings:

FIG. 1 shows a perspective view of a snap-on sealing ring according to some aspects of the present disclosure;

FIG. 2 shows a half-sectional view of the snap-on sealing ring of FIG. 1 according to some aspects of the present disclosure;

FIG. 3 shows a partial sectional view of the snap-on sealing ring of FIG. 1 according to some aspects of the present disclosure;

FIG. 4 shows another partial sectional view of the snap-on sealing ring of FIG. 1 according to some aspects of the present disclosure;

FIG. 5 shows a first example of a metallic insert according to some aspects of the present disclosure;

FIG. 6 shows a second example of a metallic insert according to some aspects of the present disclosure;

FIG. 7 shows a longitudinal sectional view of a non-contact wheel bearing pre-seal according to some aspects of the present disclosure; and

FIG. 8 shows a representation illustrating the use of the snap-on sealing ring as a mounting aid for two components to be joined to one another, including an axially clamped face serration assembly with a pre-assembly position on the left and a final assembly position on the right according to some aspects of the present disclosure.

### DETAILED DESCRIPTION

As disclosed in various examples herein, embedding a metal insert into the plastic base body creates a strong press fit between the first component and the snap-on sealing ring, preventing corrosion from pushing open and propagating beneath the joining site. This arrangement provides metallic contact at the joining site between the metal insert and the relevant shaft section of the first component, which is likewise typically made of metal. A secure press fit is thereby enabled over a wide temperature range.

Exposed sections of the metal insert facilitate pressing of the snap-on sealing ring onto the shaft section and engagement by a corresponding tool. In addition, the exposed sections promote sealing of an injection molding tool during molding of the plastic base body, since the insert rests metallically against the tool halves.

The sleeve section, including catch lugs made of plastic, preserves a degree of axial flexibility of the base body. This enables axial end-face sealing against the second component, thereby preventing the formation of a corrosion-prone gap beneath the snap-on sealing ring. As a result, the shaft connection does not require coating or other additional corrosion protection.

The insert can be produced particularly cost-effectively as a sheet metal part, for example.

The use of a steel sheet having a galvanized surface can further enhance corrosion protection. The steel sheet may be provided as a galvanized sheet or may be galvanized after forming.

Alternatively, a stainless steel alloy or an aluminum alloy can be used for the insert.

Recesses can also be formed in the insert that interlock positively with the plastic material of the base body. This provides an intimate connection that better withstands potential torsional forces, which may arise, for example, due to friction caused by contamination.

The recesses can be produced with little effort, for example, as holes and/or notches at the outer ring disk section, such as during a punching operation of the insert.

In another example, a circumferential collar can be formed at the flange section as a retaining wall in the radial direction, together with wings extending to the collar. During rotation, such a structure acts as a centrifugal pump to generate a defined air flow along the flange section. This air flow can be used, for example, in a gap-type seal to generate a pressure gradient in a particular direction, preferably counteracting ingress through the seal.

In a further example, plastic material of the base body may be absent from the outer ring disk section, at least in the region where it connects to the sleeve-shaped connecting section, on the side that transitions into the contact surface of the connecting section. This configuration facilitates pressing of the snap-on sealing ring onto a shaft step and defined axial bearing against a shoulder of the shaft step. As a result, the positioning of the snap-on sealing ring can be precisely controlled. This is particularly advantageous when the snap-on sealing ring, for example within an axially clamped face serration assembly, is clamped against a corresponding surface of the second component or against a resilient sealing element arranged there to effectuate axial end-face sealing.

The snap-on sealing ring described above is preferably used in an axially clamped face serration assembly as recited in claim 9. In addition to its sealing function, the ring may also serve as a mounting aid.

The snap-on sealing ring described above can also be used in a non-contact wheel bearing pre-seal as recited in claim 10. In particular, the creation of wings and a circumferential retaining wall at the flange section is conducive to generating a flow directed against the overcoming of the pre-seal.

The wings, together with the cells formed therebetween, act in the manner of a centrifugal pump during rotation of the snap-on sealing ring. Medium displaced radially outward, such as water or air, is deflected in the axial direction by the retaining walls, thereby generating a flow in front of and/or within the sealing gap. Such a flow inhibits ingress of water and dirt, while also promoting removal of water and dirt that may already have entered the region to be sealed. The effectiveness of the wheel bearing pre-seal is thereby considerably enhanced in a simple manner, permitting the actual wheel bearing seal to be of especially simple and/or low-friction design.

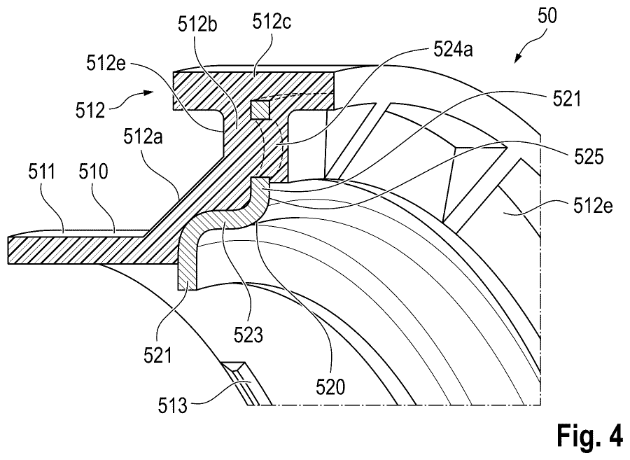

The snap-on sealing ring 50 shown in FIGS. 1 to 6 by way of example comprises a base body 510 made of plastic and an insert 520 made of metal.

The base body 510 is preferably molded onto the metal insert 520; however, a connection between the base body 510 and the insert 520 can also be established in another manner.

The base body 510 comprises a sleeve section 511 having a longitudinal axis A and a flange section 512 that axially adjoins the sleeve section 511.

The outside diameter of the flange section 512 is greater than the outside diameter of the sleeve section 511. In addition, the inside diameter of the sleeve section 511 is smaller than the inside diameter of the flange section 512.

Preferably, at least the sleeve section 511 has a constant wall thickness.

The base body 510 further comprises at least one catch lug 513 for latchingly engaging with a first component, the catch lug 513 being formed radially on the inside or radially on the outside of the sleeve section 511. The number of catch lugs 513 can be smaller or larger than shown and preferably ranges between approximately 3 and 20.

In the illustrated example, the flange section 512, subsequent to the sleeve section 511, first comprises an approximately conical transition region 512a before transitioning into a radial annular region 512b.

A circumferential collar 512c can optionally be formed in the radial direction on the outer circumference of the flange section 512 and serve as a retaining wall, the collar 512c extending axially to one side or to both sides beyond the annular region 512b.

Optionally, projecting wings 512d that extend radially outward to the collar 512c can be provided at the flange section 512, in particular at the radial annular region 512b, on one side or on both sides. Recessed pockets or cells 512e are formed in each case between adjoining wings 512d.

The wings 512d cooperate with the collar 512c to generate, during rotation of the snap-on sealing ring 50, a flow that is initially deflected radially outward and then deflected in the axial direction by the collar 512c.

The insert 520 made of metal comprises an outer ring disk section 521 and an inner ring disk section 522 that is arranged axially offset from the outer ring disk section 521. The metal insert 520 further comprises a sleeve-shaped connecting section 523 that connects the outer ring disk section 521 and the inner ring disk section 522 to one another.

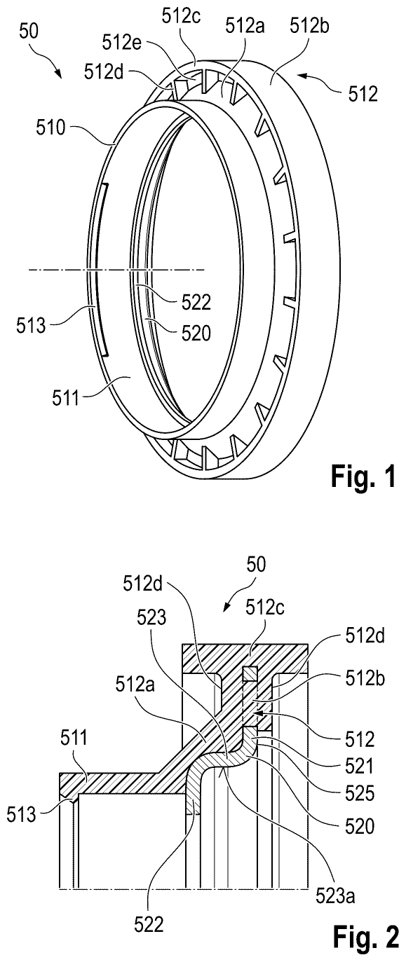

As is apparent in particular in FIG. 2, the outer ring disk section 521 transitions on its inner radial side into the sleeve-shaped connecting section 523, and the inner ring disk section 522 transitions on its outer radial side into the sleeve-shaped connecting section 523.

The insert 520 is preferably a sheet-metal part provided by forming, for example from a sheet-metal blank.

In particular, the insert 520 made of sheet steel can have a galvanized surface to ensure enhanced corrosion protection, or may be made of a stainless-steel alloy or an aluminum alloy.

As previously mentioned, the base body 510 and the insert 520 are connected to one another to form a component having the following special features.

To begin with, the outer ring disk section 521 of the insert 520 is embedded, at least in sections, into the flange section 512 of the base body 510. Subregions of the outer ring disk section 521 are thus surrounded on both sides by material of the base body 510. This provides a particularly stable connection between the base body 510 and the insert 520 and reinforces the base body 510, especially in the region of the flange section 512.

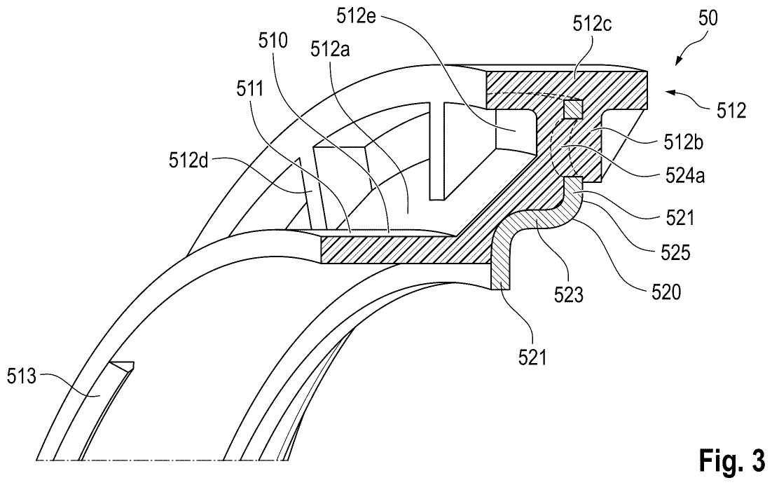

To achieve a particularly intimate connection between the base body 510 and the insert 520, a partial form-fit can be implemented, as indicated in FIGS. 3 to 6.

For this purpose, recesses 524 can be formed in the insert 520 that interlock with the plastic material of the base body 510.

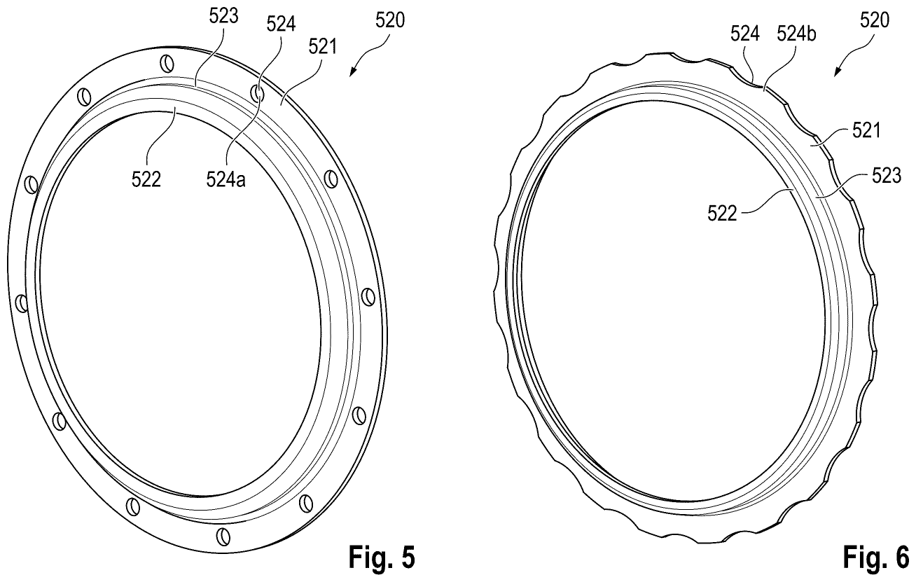

In the variant embodiment of the insert 520 shown in FIG. 5, the recesses 524 are formed by holes 524a at the outer ring disk section 521 through which, as shown for example in FIG. 2, material of the base body 510 extends.

In FIG. 6, by contrast, the recesses 524 are notches 524b at the outer ring disk section 521, which can be provided, for example, on the outer circumference of the outer ring disk section 521.

Other spatial structures, in particular those that can be formed during the same operation in which the insert 520 is shaped, can likewise be used for engagement with the base body 510 so as to ensure a highly torsion-resistant connection between the base body 510 and the insert 520.

It is furthermore apparent from FIG. 2 that the inner ring disk section 522 has a smaller inside diameter than the sleeve section 511 and the flange section 512.

This means that the inner ring disk section 522 projects inward from the base body 510 and is not covered with material of the base body 510 over this distance and consequently forms a metallic outer surface on the snap-on sealing ring 50.

The sleeve-shaped connecting section 523 forms, on its radial inner side, a contact surface 523a for pressing onto a shaft section of a second component. In other words, in this region the insert 520 is not covered by plastic material of the base body 510.

By contrast, on its radial outer side, the sleeve-shaped connecting section 523 of the insert 520 is in contact with the plastic material of the base body 510, and the base body 510 is directly connected to the insert 520 at this location.

This configuration enables metallic attachment of the snap-on sealing ring 50 to the second component, permitting high pressing forces. Such a solid connection is less susceptible to corrosion because it is difficult to compromise by rust infiltration, and moisture cannot readily penetrate beneath the joint. Moreover, the exposed region at the inner ring disk section 522 of the insert 520 allows reliable engagement of a pressing tool when the snap-on sealing ring 50 is mounted to the shaft section of the second component.

Furthermore, the outer ring disk section 521—at least in the region 525 where it connects to the sleeve-shaped connecting section 523—can likewise be free of plastic material of the base body 510 on the side that transitions into the contact surface 523a of the sleeve-shaped connecting section 523. This favors metallic contact with a shoulder of a shaft step and thus precise positioning of the snap-on sealing ring 50 on the second component.

Such a two-component snap-on sealing ring 50 can be produced in a cost-effective manner.

The snap-on sealing ring 50 can be used for externally sealing a shaft connection as described hereafter, which shall also be understood to include shaft sections of two components to be connected to one another, namely a first component and a second component. The snap-on sealing ring 50 protects the joining site between the two components against the penetration of moisture.

During assembly, the snap-on sealing ring 50 is pressed, via its metallic contact surface 523a, onto the shaft section of the second component, optionally until the region 525 bears against a shoulder formed at the shaft step. Thereafter, the shaft section of the first component is joined to that of the second component. The sleeve section 511 of the snap-on sealing ring 50 becomes engaged with the first component. In particular, the sleeve section 511 can be at least pre-fixed to the first component by way of the catch lugs 513. Moreover, the sleeve section 511 can be pushed, axially at its end face, into sealing contact with the first component or with a sealing element 25 arranged thereon in a sealed manner.

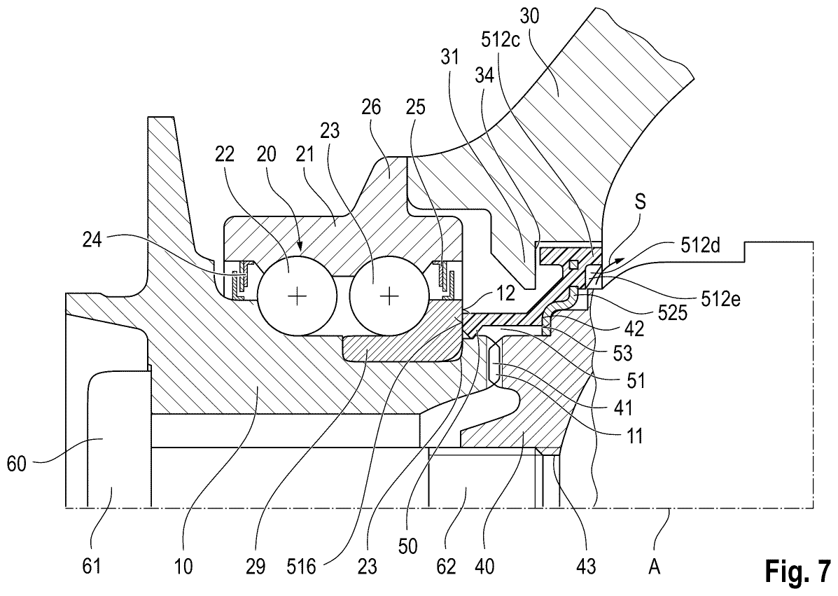

FIG. 7 shows an exemplary embodiment of a wheel bearing assembly comprising a non-contact wheel bearing pre-seal. The assembly includes a wheel hub 10; a wheel bearing 20 arranged at the wheel hub 10; a wheel carrier 30, to which the wheel bearing 20 with a wheel bearing outer ring 21 is attached; and a journal 40, which in this example is a constant velocity joint of a drive shaft coupled to the wheel hub 10 in a torque-transmitting manner. The coupling can be established by way of an axial serration or the like, or, in particular, by way of an axially clamped face serration assembly 11/41 described in more detail below.

The wheel bearing assembly further comprises a non-contact wheel bearing pre-seal including a snap-on sealing ring 50 of the type described above. The snap-on sealing ring 50 is attached to the wheel hub 10, the wheel bearing 20, and/or the journal 40 and, together with a mating contour present at the wheel carrier 30 or at a component attached to the wheel carrier 30, forms a sealing gap.

In the figures described in more detail hereafter, the snap-on sealing ring 50 of the non-contact wheel bearing pre-seal is mounted upstream of an actual wheel bearing seal of the wheel bearing 20 on the side facing away from the wheel. However, it is also possible, in principle, to mount the wheel bearing pre-seal upstream of the wheel-side wheel bearing seal.

Moreover, the non-contact wheel bearing pre-seal is explained hereafter in connection with a wheel bearing assembly in which the wheel hub 10 is coupled to the journal 40 of a drive shaft by way of a face serration assembly 11/41. As noted above, instead of such a coupling having a face serration assembly 11/41, other coupling structures can also be provided between the wheel hub 10 and the journal 40.

The sealing ring 50 of the wheel bearing pre-seal can surround the face serration assembly or an alternative coupling structure radially on the outside and seal it. The snap-on sealing ring 50 can be pre-mounted on the journal 40 or constant velocity joint and, in the assembled state of the wheel bearing assembly, can engage with the wheel hub 10 outside the force path of the wheel bearing 20.

In FIG. 7, the snap-on sealing ring 50, in cooperation with the wheel carrier 30, forms a non-contact pre-seal for the wheel bearing 20 so as to inhibit water and dirt from reaching the wheel bearing 20.

For example, the snap-on sealing ring 50 can have an end face 516 that, in the assembled state, is pushed against an opposing end wall 12 of the wheel hub 10.

Additional dedicated wheel bearing seals 24 and 25, which seal the rolling bearings 22 and 23 to the outside, are provided at the wheel bearing 20. The rolling bearings 22 and 23 can mount the wheel bearing outer ring 21 so as to be rotatable with respect to the wheel hub 10. The wheel-side seal is the wheel bearing seal 24, and the seal arranged away from the wheel is the wheel bearing seal 25. The non-contact wheel bearing pre-seal provided by the snap-on sealing ring 50 is spaced apart from the rolling bearings 22 and 23 and is located between the journal 40 or constant velocity joint and the wheel carrier 30. Due to the pre-seal provided by the snap-on sealing ring 50, the dedicated wheel bearing seals 24 and 25 of the wheel bearing 20 can have an especially low-friction design.

The rolling bearings 22 and 23 can be designed as complete bearings, each comprising a dedicated bearing inner ring and a dedicated bearing outer ring as well as interposed rolling elements. However, it is also possible to integrate individual bearing rings into a shared wheel bearing outer ring 21 and/or into the wheel hub 10.

In FIG. 7, the bearing outer rings of the rolling bearings 22 and 23 are combined into a shared wheel bearing outer ring 21, which can additionally form supporting and attachment structures 26 for connection to the wheel carrier 30.

For the rolling bearing 22 shown on the left of FIG. 7, which lies furthest from the constant velocity joint, the bearing inner ring is integrated into the wheel hub 10. By way of example, for the rolling bearing 23 shown on the right of FIG. 7, which lies closest to the constant velocity joint, the bearing inner ring 29 is designed as a dedicated component. The bearing inner ring 29 may also be understood hereafter as an integral part or sub-section of the wheel hub 10. In this regard, depending on the configuration of the bearing inner rings, the snap-on sealing ring 50 of the non-contact wheel bearing pre-seal can also be supported on an end wall 12 of such a bearing inner ring 29, which in this case acts as part of the wheel hub 10.

If separate bearing rings are present, these can be axially fixed to and supported on the wheel bearing outer ring 21 or on the wheel hub 10 by suitable axial securing means, such as bearing shoulders, axial securing rings, receiving grooves, or the like. The bearing inner ring 29 can, for example, be fixed to the wheel hub 10 by forming an end section of the wheel hub 10, such as by orbital forging or orbital pressing. The snap-on sealing ring 50 of the non-contact wheel bearing pre-seal therefore does not need to absorb axial bearing forces. Because this ring also does not perform a supporting function, there is greater design freedom for the sealing ring 50 of the non-contact wheel bearing pre-seal, and complex shapes are possible.

This configuration also enables integration with a wheel speed sensor, the transmitter of which is arranged as a ring in the wheel bearing seal 25. The associated pick-up can, for example, be arranged axially between the wheel bearing seal 25 and the snap-on sealing ring 50 of the non-contact wheel bearing pre-seal, while the associated sensor housing can be seated-together with further components of the wheel speed sensor—in a cut-out or bore at the wheel carrier 30.

As an alternative or in addition to providing a non-contact pre-seal for the wheel bearing 20, the snap-on sealing ring 50 can surround the face serration assembly 11/41 radially on the outside and seal it, thereby protecting it against corrosion. For this purpose, the snap-on sealing ring 50 of the non-contact wheel bearing pre-seal can, for example, be axially clamped between the wheel hub 10 and the constant velocity joint 40. In particular, the snap-on sealing ring 50 is pressed, via its contact surface 523a, onto a shaft step at the journal 40 and is seated, via its region 525, against a shaft step shoulder, with metallic contact present at both locations.

In FIG. 7, the face serration assembly 11/41 forms the interface between the constant velocity joint 40 and the wheel hub 10. A respective face serration 11 or 41 is formed at mutually opposing end walls of the wheel hub 10 and the constant velocity joint 40, and the teeth of these two face serrations 11 and 41 mesh with one another. In the present example, a “face serration” is an end-face radial serration structure on a component that can be coupled with a corresponding end-face radial serration structure on another component for transmitting torque. The toothing engagement has zero backlash and is suitable for transmitting high torque. Such face serration assemblies are also referred to as Hirth joints or face gearing systems.

A clamping device 60, preferably in the form of a clamping bolt, is used in the clamped state to hold the two face serrations 11 and 41 in the meshed state with one another at the wheel hub 10 and at the constant velocity joint 40.

The clamping device 60 preferably extends centrally through the two face serrations 11 and 41. In particular, the clamping device 60, or the clamping bolt, can be supported with a head 61 at the wheel hub 10 and be bolted to the constant velocity joint 40 by way of a thread 62. A reverse installation is likewise possible.

As noted above, the snap-on sealing ring 50 of the wheel bearing pre-seal forms a sealing gap together with a mating contour located at the wheel carrier 30 or a component attached to the wheel carrier 30. To enhance the sealing action, wings 512d can be provided on the snap-on sealing ring 50, with cells 512e formed between adjacent wings 512d in the circumferential direction. The number of wings 512d is on the order of 1 to 60.

The wings 512d do not necessarily have to be strictly radial; they may be inclined at an angle of approximately +20° with respect to the radial direction. The wings 512d may also be provided with curvature in the radial direction, wherein tangents to the wings 512d include an angle of no more than approximately +20° with the radial direction.

The cells 512e are each delimited radially on the outside by the retaining wall 512c, which in turn delimits the sealing gap radially on the inside. In contrast, the cells 512e are preferably open radially to the inside. During rotation of the snap-on sealing ring 50, a flow opposite to that required to overcome the seal is thereby generated in front of or within the sealing gap. This flow inhibits water and dirt from entering the sealing gap, and water and dirt that has already penetrated is removed to the outside by the flow. The sealing action of the non-contact pre-seal is thus significantly increased.

This effect is indicated in FIG. 7 by an arrow S, which illustrates the flow direction of the medium (air and/or water) present upstream of the snap-on sealing ring 50. Due to rotation of the snap-on sealing ring 50, the medium is entrained by the wings 512d and, due to centrifugal force, flows radially outward before being deflected by the retaining wall 512c of the respective cell 512e.

If the wings 512d and cells 512e are arranged on the seal outer side of the snap-on sealing ring 50, the medium is conducted away from the snap-on sealing ring 50 in the region of the opening of the sealing gap. This substantially axial flow at the outer-side opening of the sealing gap produces a suction effect that further impedes ingress of water and dirt and removes water and dirt that may already have entered.

Corresponding wings 512d and cells 512e can also be arranged on the seal inner side of the snap-on sealing ring 50. The flow generated by the centrifugal-pump effect can be directed at the sealing gap so as to generate a flow from the inside to the outside within the sealing gap.

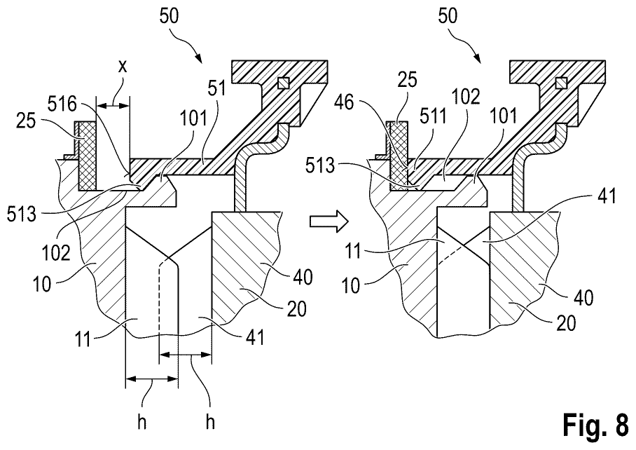

As explained with reference to FIG. 8, the snap-on sealing ring 50 can also be used as a mounting aid during assembly of the wheel bearing assembly. During assembly of a face serration assembly, it should be ensured that the corresponding face serrations 11 and 41 correctly mesh with one another to prevent tooth-on-tooth assembly.

FIG. 8 shows, on the right, an axially clamped face serration assembly in a clamped final assembly position and, on the left, the assembly during a pre-assembly stage.

In the present example, a “face serration” is an end-face radial serration structure on a component configured to couple with a corresponding end-face radial serration structure on another component for transmitting torque. The axially clamped face serration assembly further comprises the second face serration 41 at the cardan shaft 40. The first face serration 11 and the second face serration 41 are in toothing engagement with one another. In FIG. 8 this toothing engagement is backlash-free and suitable for transmitting high torque.

The axially clamped face serration assembly further comprises a clamping device 60, preferably in the form of a clamping bolt, by which, in the clamped state, the first face serration 11 and the second face serration 41 are axially clamped to one another. The clamping device 60 preferably extends centrally through the two face serrations 11 and 41. In particular, the clamping device 60 (the clamping bolt) can be supported on the wheel hub 10 and bolted to the constant velocity joint 40; a reverse installation is likewise possible.

The sealing ring 50 surrounds the first face serration 11 and the second face serration 41 radially on the outside and seals them. The first face serration 11 and the second face serration 41 are held loosely in engagement by the snap-on sealing ring 50, as described in more detail below. This loosely engaged state is regarded as a pre-assembly position in which the wheel hub 10 and the constant velocity joint 40 are already roughly aligned with respect to one another and are secured by the snap-on sealing ring 50 to prevent the components from coming apart.

As indicated on the left in FIG. 8, in the pre-assembly position an axial play x between the two face serrations 11 and 41 is smaller than the tooth height h of the first face serration 11 and of the second face serration 41. Once the pre-assembly position has been reached, a tooth-on-tooth position of the teeth of the first face serration 11 and the second face serration 41 is therefore precluded.

In a second step, after the pre-assembly position has been established, the clamping device 60 can be tightened to create the backlash-free engagement between the first face serration 11 and the second face serration 41 and thereby reach the final assembly position shown on the right in FIG. 8.

In the final assembly position, penetration of moisture and dirt from the outside into the joint between the first face serration 11 and the second face serration 41 is reliably suppressed by the snap-on sealing ring 50, thereby protecting the toothing engagement against corrosion.

The arrangement of the snap-on sealing ring 50 relative to the wheel hub 10 and the constant velocity joint 40, as well as the configuration of the snap-on sealing ring 50, can be implemented in various ways, as described below. The arrangement and any engagement structures with respect to the constant velocity joint 40 as the first component and the wheel hub 10 as the second component can essentially also be reversed.

In one variant embodiment, as shown by way of example in FIG. 8, the snap-on sealing ring 50 can be fixed to one of the first and second components, while the ring is coupled to the other of the first and second components by way of a detent mechanism. Based on the latching engagement, it can be reliably recognized that the pre-assembly position has been reached, i.e., a tooth-on-tooth position is precluded.

The snap-on sealing ring 50 can be fixed to one of the first and second components—by way of example to the constant velocity joint 40 as the first component—by press-fitting, adhesive bonding, or in another manner. Preferably, this is performed before the two components, namely the wheel hub 10 and the constant velocity joint 40, are joined to achieve the pre-assembly position.

For the detent mechanism, catch lugs 513 are formed at the snap-on sealing ring 50 and distributed around its circumference. After overcoming a protrusion 101 at the other component—by way of example, the second component or the wheel hub 10—the catch lugs 513 engage in one or more recesses 102 at the other (second) component. In principle, a single catch lug 513 may also be sufficient.

The protrusion 101 and the recess 102 can be designed as continuously circumferential structures so that the angular position of the snap-on sealing ring 50 about the circumference is immaterial during assembly. Alternatively, the protrusion 101 can be provided by multiple individual protrusions and/or the recess 102 can be provided by multiple individual recesses.

In a modification of the illustrated embodiments, the catch lugs 513 can also be arranged on an outer circumferential surface of the snap-on sealing ring 50 instead of on an inner circumferential surface. Accordingly, the protrusion 101 and the recess 102 of the second component are then located on an inner circumferential section of the second component.

As noted above, in the unclamped state of the clamping device 60 the catch lugs 513 are accommodated with axial play in the corresponding recess 102 (or recesses 102). When the protrusion 101 is overcome by the catch lugs 513, the overlap of the teeth of the first face serration 11 and of the second face serration 41 is preferably 30% to 90% of the tooth height.

To facilitate assembly, the snap-on sealing ring 50 can be radially elastically compressible and extendable at the sleeve section 511 on which the catch lugs 513 are formed, thereby enabling the detent resistance formed by the protrusion 101 to be overcome more easily.

Chamfers formed at the catch lugs 513 and/or at the protrusion 101 can also support this function.

Furthermore, the snap-on sealing ring 50 can have a circumferential sealing surface 516 that, in the clamped state of the clamping device 60, is pushed against a corresponding sealing surface 13 at the other component—by way of example, the second component or the wheel hub 10.

The circumferential sealing surface 516 on the snap-on sealing ring 50 can be formed by an axially end-face wall section. The circumferential sealing surface 516 can be a surface perpendicular to the axial direction, a surface oblique to the axial direction, a curved surface, or a combination of two or more such surface sections. In particular, the circumferential sealing surface 516 on the snap-on sealing ring 50 and the corresponding sealing surface 13 on the other component can be conical.

The snap-on sealing ring 50 can be used as a mounting aid for positioning the components 10, 40 to be joined while avoiding a tooth-on-tooth position. The joining until the pre-assembly position has been reached can be performed in a first step or work cycle. When the clamping device 60 is later attached and tightened in a second step or work cycle, no additional holding device for the respective second component is needed in the present variant embodiments. The axial force applied during clamping is on the order of approximately 80 kN or more.

In one variant embodiment, the retaining force of the snap-on sealing ring 50 serving as a mounting aid can be designed such that axial displacement to an end position occurs as a result of the clamping force of the clamping device 60.

During assembly, the snap-on sealing ring 50 can first be fixed to the first component or to the constant velocity joint 40. The constant velocity joint 40 is thus supplied to the joining process in a state in which it has already been provided with the snap-on sealing ring 50.

Furthermore, the wheel bearing 20 is mounted to the wheel hub 10, and the wheel bearing 20 is in turn connected to the wheel carrier 30.

In a further step of the joining process, the constant velocity joint 40 and the wheel hub 10, including the wheel bearing 20, are loosely mounted to one another by way of the snap-on sealing ring 50. In this process, the first face serration 11 and the second face serration 41 become partially engaged so that the teeth overlap, while a backlash-free position has not yet been reached. In this pre-assembly position, the wheel hub 10 is fixed relative to the journal 40 or constant velocity joint 40 so that the two components can no longer be readily detached from one another, and a tooth-on-tooth position of the face serrations 11 and 41 is precluded. Such a process step is simple to implement.

In a subsequent step, the first face serration 11 and the second face serration 41 are clamped to one another by the clamping device 60. Since the wheel hub 10 has previously been pre-fixed relative to the constant velocity joint 40, no additional holding device must be provided when attaching and tightening the clamping device 60. As a result of the tightening, the first face serration 11 and the second face serration 41 come to bear against one another without backlash. The applied clamping is selected as a function of the torque to be transmitted. This process step is also simple to implement. When the final assembly position has been reached, the snap-on sealing ring 50 seals the engagement of the first face serration 11 with the second face serration 41 radially to the outside. At this stage, the snap-on sealing ring 50 no longer serves as a mounting aid but as a sealing device. At the same time, the snap-on sealing ring 50 engages with the wheel carrier 30 to provide the pre-seal for the wheel bearing 20.

The axially clamped face serration assembly can be disassembled, including by non-destructive means. This is advantageous in the event that service is required.

For this purpose, the detent mechanism can be designed such that detachment of the catch lugs 513 is possible by applying a high axial force or a bending moment. Correspondingly adapted contact slopes or chamfers can be provided for this purpose.

A method for disassembly, for example in the event of servicing, can be carried out in a simple manner as follows. The clamping device 60 is first loosened slightly, preferably in such a way that partial engagement of the face serrations 11 and 41 is preserved. The clamping bolt can, for example, be loosened by approximately 3 to 9 mm (corresponding to 2 to 6 revolutions at a pitch of 1.5 mm). Using a soft-face hammer, the head 61 of the clamping bolt is struck until the snap-on sealing ring 50 detaches in the region of the detent mechanism. The constant velocity joint 40 is prevented from falling by virtue of the clamping bolt not being loosened completely. After the snap-on sealing ring 50 has been released, the clamping device 60 (the clamping bolt) can then be unscrewed entirely.

The present disclosure has been described in detail above with reference to exemplary embodiments and further modifications. Individual technical features described above in connection with other features can also be implemented independently of them or in combination with further features, even if this has not been expressly stated, provided this is technically feasible. It should also be emphasized that the collar and wings can be omitted in all examples. Accordingly, the present disclosure is not limited to the described exemplary embodiments and modifications but encompasses all configurations defined by the claims.

### LIST OF REFERENCE SIGNS

10 wheel hub
11 first face serration
12 end wall
13 sealing surface
20 wheel bearing
21 wheel bearing outer ring
22 rolling bearing
23 rolling bearing
24 wheel bearing seal
25 wheel bearing seal
26 supporting and attachment structure
29 bearing inner ring
30 wheel carrier
31 protrusion
32 axial ring wall
33 inner edge of the protrusion
34 annular groove of the protrusion
35 inner edge of the annular groove
40 journal or constant velocity joint
41 second face serration
42 wall step
43 thread opening
50 snap-on sealing ring
60 clamping device
61 head
62 thread/threaded section
101 protrusion
102 recess
201 protrusion
202 recess
510 base body made of plastic material
511 sleeve section
512 flange section
512a radial ring section
512b transition section
512c collar/retaining wall
512d wings
512e cell
513 catch lug
516 sealing surface
520 insert made of metal
521 outer ring disk section
522 inner ring disk section
523 connecting section, sleeve-shaped
523a contact surface, metallic
524 recess
524a hole
524b notch
525 region
h tooth height
x axial play
A axis-corresponding to the axis of rotation of wheel hub, journal, and seal
S flow direction

1. A snap-on sealing ring for externally sealing a shaft connection, comprising:
a base body made of plastic, the base body comprising:
a sleeve section;
a flange section axially adjoining the sleeve section; and
at least one catch lug formed on the sleeve section for latchingly engaging with a first component; and
an insert made of metal, the insert comprising:
an outer ring disk section;
an inner ring disk section arranged axially offset from the outer ring disk section; and
a sleeve-shaped connecting section connecting the outer ring disk section and the inner ring disk section to one another,
wherein the outer ring disk section is embedded at least in part into the flange section,
wherein the inner ring disk section has a smaller inside diameter than the sleeve section and the flange section,
wherein the sleeve-shaped connecting section defines a metallic contact surface on a radially inner side for pressing onto a shaft section of a second component, and
wherein the sleeve-shaped connecting section on a radially outer side is in contact with the plastic of the base body.

2. The snap-on sealing ring of claim 1, wherein the insert is a sheet metal part.

3. The snap-on sealing ring of claim 1, wherein the insert comprises a galvanized steel sheet, a stainless steel alloy, or an aluminum alloy.

4. The snap-on sealing ring of claim 1, wherein the insert comprises recesses that are interlocked with the plastic of the base body.

5. The snap-on sealing ring of claim 4, wherein the recesses comprise holes through the outer ring disk section or notches along a circumference of the outer ring disk section.

6. The snap-on sealing ring of claim 1, further comprising a circumferential collar formed as a retaining wall on the flange section and wings extending radially outward toward the collar.

7. The snap-on sealing ring of claim 1, wherein the outer ring disk section, at least in a region where it connects to the sleeve-shaped connecting section, is free of plastic on a side transitioning into the metallic contact surface of the sleeve-shaped connecting section.

8. The snap-on sealing ring of claim 1, wherein the base body is molded onto the insert.

9. An axially clamped face serration assembly, comprising:
a first component comprising a first face serration;
a second component comprising a second face serration, the first face serration and the second face serration being in toothing engagement with one another and being axially clamped to one another; and
a snap-on sealing ring surrounding the first face serration and the second face serration radially on an outside and sealing the same;
the snap-on sealing ring being pressed onto a shaft step at the first component by way of a metallic contact surface of a sleeve-shaped connecting section of a metallic insert;
the snap-on sealing ring engaging, with axial play, in one or more recesses at the second component by way of at least one catch lug of a plastic base body; and
the snap-on sealing ring further comprising, at an axial end face, a circumferential sealing surface configured to bear against the second component or against a sealing element arranged thereon when a backlash-free assembly position of the first and second face serrations is reached.

10. The axially clamped face serration assembly of claim 9, wherein the metallic insert of the snap-on sealing ring is a sheet metal part.

11. The axially clamped face serration assembly of claim 9, wherein the metallic insert of the snap-on sealing ring comprises a galvanized steel sheet, a stainless steel alloy, or an aluminum alloy.

12. The axially clamped face serration assembly of claim 9, wherein the metallic insert of the snap-on sealing ring comprises recesses interlocked with the plastic base body.

13. The axially clamped face serration assembly of claim 12, wherein the recesses comprise holes through an outer ring disk section of the insert or notches along a circumference of the outer ring disk section.

14. The axially clamped face serration assembly of claim 9, wherein the snap-on sealing ring further comprises a circumferential collar formed as a retaining wall on a flange section of the plastic base body and wings extending radially outward toward the collar.

15. The axially clamped face serration assembly of claim 9, wherein an outer ring disk section of the metallic insert, at least in a region where it connects to the sleeve-shaped connecting section, is free of plastic on a side transitioning into the metallic contact surface.

16. The axially clamped face serration assembly of claim 9, wherein the plastic base body of the snap-on sealing ring is molded onto the metallic insert.

17. A non-contact wheel bearing pre-seal assembly, comprising:
a wheel carrier;
at least one of a wheel hub, a wheel bearing, and a journal; and
a snap-on sealing ring mounted to the wheel hub, the wheel bearing, or the journal, the snap-on sealing ring comprising a plastic base body and a metallic insert, the snap-on sealing ring being retained by at least one catch lug engaging a corresponding recess of the hub, bearing, or journal, the snap-on sealing ring further comprising a flange section that cooperates with a mating contour of the wheel carrier or of a component attached to the wheel carrier to define a non-contact sealing gap configured to inhibit ingress of moisture and contaminants into the wheel bearing.

18. The assembly of claim 17, wherein the flange section comprises a circumferential collar formed as a retaining wall and wings extending radially outward toward the circumferential collar, the collar and wings being configured to generate an air flow along the flange section during rotation of the snap-on sealing ring.

19. The assembly of claim 17, wherein the non-contact sealing gap is located upstream of dedicated wheel bearing seals of the wheel bearing and is configured to reduce the sealing load of the dedicated wheel bearing seals.

20. The assembly of claim 17, wherein the metallic insert of the snap-on sealing ring comprises recesses positively interlocked with the plastic base body, and wherein the plastic base body is molded onto the metallic insert.
